(19) United States
(12) Patent Application Publication
(10) Pub. No.: US 2015/0199152 A1
(43) Pub. Date: Jul. 16, 2015

(54) METHOD OF MANAGING REDUNDANT ARRAY OF INDEPENDENT DISKS (RAID) GROUPS IN A SOLID STATE DISK ARRAY

(71) Applicant: Avalanche Technology, Inc., Fremont, CA (US)

(72) Inventor: Mehdi Asnaashari, Danville, CA (US)

(73) Assignee: Avalanche Technology, Inc., Fremont, CA (US)

(21) Appl. No.: 14/157,394

(22) Filed: Jan. 16, 2014

(51) Int. Cl. G06F 3/06

(52) U.S. Cl. CPC G06F 3/0689; G06F 3/0604; G06F 3/0646

(57) ABSTRACT

A method of managing redundant array of independent disk (RAID) groups in a storage system includes determining wear of each of the plurality of RAID groups, computing the weight for each of RAID groups based on the wear, and striping data across at least one of the RAID groups based on the weight of each of the RAID groups.

### BACKGROUND OF THE INVENTION

1. Field of the Invention

This invention relates generally to redundant array independent disks (RAIDs) and particularly to RAIDs made of solid state disks.

2. Description of the Prior Art

There is no dispute that large storage is commonly employed for various reasons among which, by way of example, is on-line transactions and searches. Redundant Array of independent disks (RAID), as its name suggests, is storage space of a large capacity and redundancy.

In some applications, SSDs are grouped together based on some criterion to create a RAID group and a storage system may support many RAID groups. Initially, a predetermined number of RAID group(s) are placed into a storage system and at a later time, additional RAID groups, may be added to expand capacity and add performance.

Because SSDs within the RAID groups are made of non-volatile storage, they have a finite lifetime hence RAID groups have a finite lifetime. As indicated above, during operation of a storage system utilizing RAIDs, new RAID groups are oftentimes added to the storage system for various reasons. Nearly every time a new RAID group is added, the existing RAID groups and the new RAID groups get utilized evenly and hence, the existing RAID groups reach end-of-life sooner than newly added RAID groups. Currently, as soon as one of the RAID groups reaches end-of-life the entire storage system ceases to operate properly since the data is evenly striped across the SSDs in all RAID groups. This is clearly undesired because it is a waste of resources and costly.

Thus, there is a need for a storage system using RAIDs to have increased efficiency and reduced costs.

### SUMMARY OF THE INVENTION

Briefly, a method of managing redundant array of independent disk (RAID) groups in a storage system includes determining wear of each of the plurality of RAID groups, computing the weight for each of RAID groups based on the wear, and striping data across at least one of the RAID groups based on the weight of each of the RAID groups.

These and other objects and advantages of the invention will no doubt become apparent to those skilled in the art after having read the following detailed description of the various embodiments illustrated in the several figures of the drawing.

### IN THE DRAWINGS

FIG. 1 shows a storage system (or “appliance”) 8, in accordance with an embodiment of the invention.

FIG. 2 shows relevant portions of the storage system 8, in accordance with an embodiment of the system.

FIG. 3 shows a flow chart of a process performed by the CPU subsystem 14 when a new RAID group is added to the storage system, in accordance with methods of the invention.

### DETAILED DESCRIPTION OF THE VARIOUS EMBODIMENTS

In the following description of the embodiments, reference is made to the accompanying drawings that form a part hereof, and in which is shown by way of illustration of the specific embodiments in which the invention may be practiced. It is to be understood that other embodiments may be utilized because structural changes may be made without departing from the scope of the invention. It should be noted that the figures discussed herein are not drawn to scale and thicknesses of lines are not indicative of actual sizes.

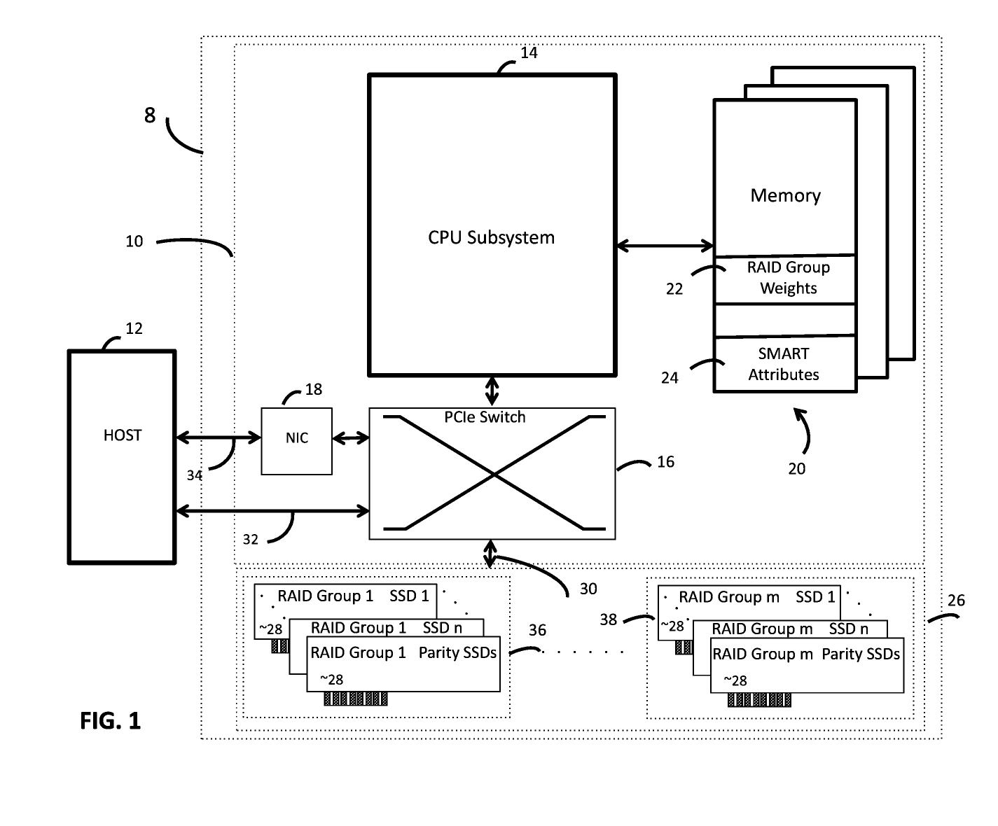

Referring now to FIG. 1, a storage system (or “appliance”) 8 is shown in accordance with an embodiment of the invention. The storage system 8 is shown to include storage processor 10 and redundant array of independent disks (RAID) groups 36 through 38, which create a storage pool 26. The storage system 8 is shown coupled to a host 12. In an embodiment of the invention, the independent disks of the RAID groups 36 through 38 comprise of plurality of Peripheral Component Interconnect Express (PCIe) solid state disks (SSD) 28.

The SSDs 28 are mostly made up of NAND flash memories. It is widely known that flash memories wear as they are being programmed and erased. There is a limit as to the number of times a flash memory can be programmed and erased. Each time the flash memory is erased, some physical damage is done to flash memory cells and over time this wear accumulates and eventually renders the flash memory unreliable or non-functional.

SSD controllers try to manage wear using many different wear leveling techniques in an effort to wear all flash memories on the SSD at the same rate. Storage processor 10 also attempts to wear the SSDs 28 at a similar rate as that of flash memories by employing striping techniques and properly managing assignment of the logical addresses or physical addresses to the SSDs or the SSDs within a RAID group. Accordingly, in accordance with various methods and embodiments of the invention, a RAID group wears at substantially the same or at substantially the same rate as its SSDs. Similarly, RAID groups placed in service at the same time have similar wear.

The storage processor 10 is shown to include a CPU subsystem 14, a PCIe switch 16, a network interface card (NIC) 18, and memory 20. The memory 20 is shown to include RAID group weight parameters (herein referred to as ‘weight’) 22 and self-monitoring analysis and reporting technology (SMART) attributes 24. The storage processor 10 is further shown to include an interface 34 and an interface 32.

SMART is a standard interface protocol that allows a disk to check its status and report it to a host system. SMART information consists of ‘attributes’ each one describing some particular aspect of drive condition such as ‘average erase count’ and ‘maximum erase count’, ‘media wearout indicator’, and ‘wear range delta’. Each drive manufacturer may define their own set of attributes but they mostly try to adhere to the standard for interoperability. Media wearout indicator for example is a normalized value of 100 for a new SSD and declines toward 1 as the SSD wears. In some implementation of the invention, ‘media wearout indicator’ is the ‘weight’. In another implementation of the invention, the ‘weight’ is based on the ‘average erase count’ and ‘maximum erase count’. The storage processor divides the ‘average erase count’ into the ‘maximum erase count ‘and computes the ‘wear’ and ‘1’ minus the ‘wear’ is the ‘weight’. For example, if the ‘average erase count’ is 2000 and ‘maximum erase count’ is 5000, the ‘wear’ is 0.4 and the ‘weight’ is 0.6.

The host 12 is shown coupled to the NIC 18 through the interface 34 and is optionally coupled to the PCIe switch 16 through the interface 32. The PCIe switch 16 is shown coupled to the storage pool 26 through PCIe interface 30. The storage pool 26 is shown to include ‘m’ RAID groups 36 through 28 with each RAID group consisting of ‘n’ number of PCIe SSDs 28 and a parity SSDs, “m” and “n” being integer values. The PCIe switch 16 is further shown coupled to the NIC 18 and the CPU subsystem 14. The CPU subsystem 14 is shown coupled to the memory 20. It is understood that the memory 20 may and typically does store additional information, not depicted in FIG. 1.

During operation, under the control of the CPU subsystem 14, data from the host is transmitted through the PCIe switch 16 to the storage pool 26.

In an embodiment of the invention, parts or all of the memory 20 is volatile, such as, without limitation, dynamic random access memory (DRAM). In other embodiments, part or all of the memory 20 is non-volatile, such as and without limitation flash, magnetic random access memory (MRAM), spin transfer torque magnetic random access memory (STTMRAM), resistive random access memory (RRAM), or phase change memory (PCM). In still other embodiments, the memory 20 is made of both volatile and non-volatile memory.

It is desirable to save the RAID group weight parameters in non-volatile memory of the memory 20 so as to maintain the information saved therein even when power is not applied to the memory 20. As will be evident shortly, maintaining the information in memory at all times is of particular importance because the information maintained in the 22 is needed for proper operation of the storage system subsequent to a power interruption.

The storage system 8 comprises of one or more RAID groups 36 through 38. Because a RAID groups uses multiple disks that appear to be a single device, it increases storage capacity, improves overall performance, and provides fault tolerance. The storage system 8 is further operable with as many as one RAID group. Additional RAID groups may be added as required later when the existing RAID groups in the system are mostly utilized and additional capacity is needed.

Storage system 8 may employ different RAID architectures depending on the desired balance between the performance and fault tolerance. These architectures are called “levels.” Level 0 for example is striped disk array without fault tolerance which implies that parity SSDs. Level 4 is striped disk array with dedicated parity SSD and level 5 is striped disk array with distributed parity across the SSDs. Level 6 is similar to level 5 with the exception of having double parity distributed across the SSDs.

During operation, the host 12 issues a read or a write command, along with data in the case of the latter. Information from the host is normally transferred between the host 12 and the processor 10 through the interfaces 32 and/or 34. For example, information is transferred through the interface 34 between the processor 10 and the NIC 18. Information between the host 12 and the PCIe switch 16 is transferred using the interface 34 and under the direction of the of the CPU subsystem 14.

In the case where data is to be stored, i.e. a write operation is consummated, the CPU subsystem 14 receives the write command and accompanying data, for storage, from the host through the PCIe switch 16, under the direction of the CPU subsystem 14. The received data is ultimately saved in the memory 20. The storage processor 10 or the CPU subsystem 14 then stripes the data across the SSDs 28 of RAID groups 36 through 38. Striping the write data across the SSDs 28 within the RAID group will cause a nearly even wear of the SSDs 28. In the event that the level of the RAID requires one or more parity, the storage processor computes the parity and writes it to the parity SSDs.

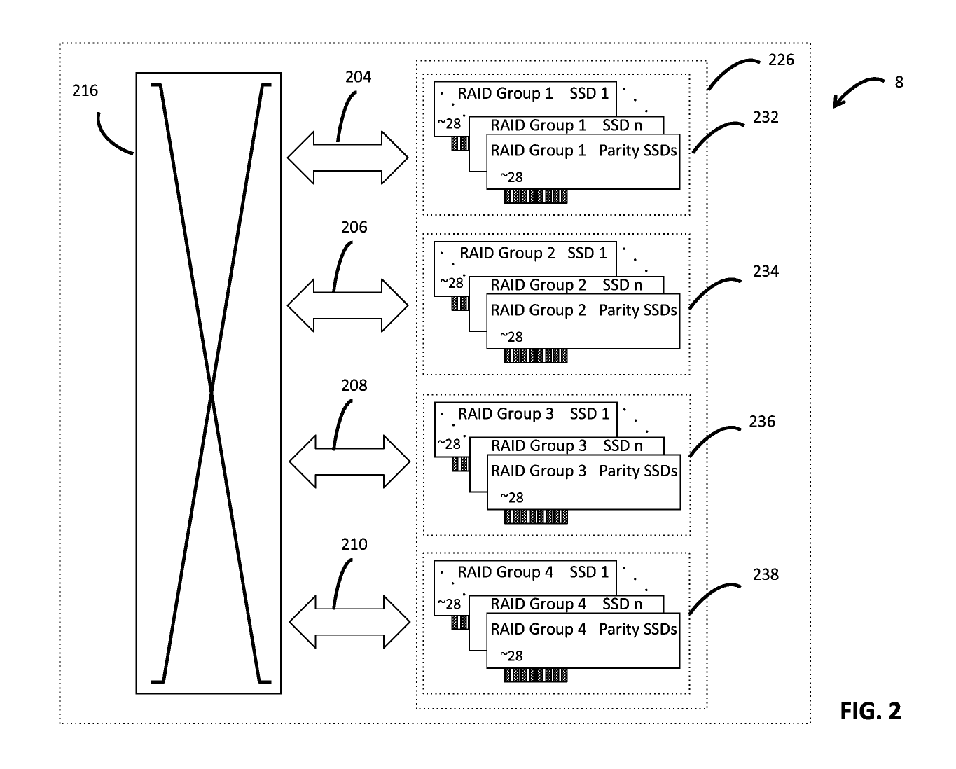

Referring now to FIG. 2, relevant portions of the storage system 8 are shown in accordance with an embodiment of the invention. More specifically, the storage system 8 is shown to include an example of a storage pool, i.e. storage pool 226, is shown in accordance with an embodiment of the invention along with a PCIe switch 216, PCIe interfaces 204, 206, 208, and 210. The PCIe switch 216 is analogous to the PCIe switch 16 of FIG. 1. The storage pool 226, which is analogous to the storage pool 26 of FIG. 1, is shown to include 4 RAID groups 232, 234, 236, and 238 with RAID group 1 being connected to the PCIe switch 216 through PCIe interface 204, RAID group 2 being connected to the PCIe switch 216 through PCIe interface 206, and so on. Aggregated PCIe interfaces 204, 206, 208, and 210 are analogous to PCIe interface 30 of FIG. 1.

As mentioned earlier, even though the storage system 8 supports a plurality of RAID groups, it is operable with one to many RAID group. Additional new RAID groups are added to the existing RAID groups when needed. The storage processor 10 then stripes the data across the SSDs 28 in the existing and new added RAID groups.

When the additional RAID groups are added to the storage system 8, the existing set of RAID groups has been in operation for a while and the SSDs within the set have worn to a certain degree. A ‘set’, as used herein, refers to RAID groups being added to the storage pool at substantially the same time. If going forward, the SSDs in the existing set of RAID groups are to be utilized at the same rate as the SSDs in the new set of RAID groups, the storage system 8 will reach its end-of-life only when the SSDs in the existing set of RAID groups have been fully worn even though the SSDs in the newly-added set of RAID groups are only partially worn and have life left in them.

To extend the life of the storage system, the CPU subsystem 14 of the storage processor 10 uses weighted striping of the write data across the SSDs in the RAID groups with a ‘weight’ being computed based on a RAID group's ‘wear’. The more worn a RAID group, the less often the storage processor stripes data across that RAID group in an attempt to assure all RAID groups reach their end-of-life at about the same time.

In the event a second set of RAID groups are added to the first set of RAID groups and the existing set of RAID groups, the storage processor re-computes the ‘wear’. The weight of each of the existing and the first set of RAID groups is based on the RAID group's ‘average wear count’ and ‘maximum erase count’ at substantially the time the third set of RAID groups is added. The storage processor 10 uses the ‘weights’ to stripe the write data across the SSDs in the three sets of RAID groups.

Regarding the terms ‘wear’ and ‘weight’, described earlier, examples of the same are now presented. In a storage system, a first set of RAID groups is added to the storage system that has an existing set of RAID group(s). The ‘wear’ of the existing set of RAID group(s) is 0.4 and a ‘weight’ of 0.6. The ‘wear’ for the first set of the RAID groups (being added) is 0 and the ‘weight’ is 1. The storage processor 10 uses the weight of the first set of RAID groups and the weight of the existing set of the RAID groups to stripe the data across the SSDs with the existing and first set of RAID groups. For example, one write data is striped across the SSDs in the first set of RAID groups for every 6 write data that is striped across the SSDs in the existing set of RAID groups. Note that storage processor 10 is not striping write data across the SSDs in the existing set of RAID groups as often as the SSDs in the first set of the RAID groups therefore, the existing set of RAID groups ‘wears’ slower than the first set of RAID groups causing both sets to reach their respective end-of-life at substantially the same time.

Assuming a second set of RAID groups is added to the storage system 8 when the first set of RAID groups has an ‘average erase count’ of 3,000, the existing set of the RAID groups should have an ‘average erase count’ of about ((3000×0.6)+2000)=3800. At the time where the second set is added, storage processor reads the ‘average erase count’ and ‘maximum erase count’ attributes and recalculates the ‘wear’ and the ‘weight’. In this example, ‘wear’ and ‘weight’ for the existing set of RAID groups is (3000/5000)=0.76 and 0.24 respectively, ‘wear’ and ‘weight’ for the first set of RAID groups is (3000/5000)=0.6 and 0.4 respectively, and ‘wear’ and ‘weight’ for the second set of RAID groups is 0 and 1 respectively. The storage processor 10 uses the weights 0.24, 0.4, and 1 to stripe write data across the SSDs in the existing, first and second RAID groups respectively. For example, for every 100 write data striped across the SSDs in the second set, 40 write data are striped across the SSDs in the first set and 24 write data are striped across the existing set.

It is understood that the storage system 8 may support any suitable number of RAID groups in its storage pool 226. In an embodiment of the invention, the storage system 8 may have available space for adding RAID group(s) to be used in the future if needed. In this embodiment, all the RAID groups are not physically present in the storage pool 226 but can be added to the available space when needed. In another embodiment of the invention, all of the RAID groups of the storage pool 226 are physically present in the storage pool 226. In the latter embodiments where RAID groups are not all physically present, a ‘weight’ of ‘0’ may be assigned to the non-present RAID groupings and a ‘wear’ can be set to a predetermined value, such as ‘1’. Obviously, no striping across the non-present RAID groups are done. In the case where a new RAID group is added, the ‘wear’ of the newly-added RAID group may be set to a predetermined value, such as ‘ 1’ and its weight set to ‘0’. None of the foregoing scenarios affect the striping methods including those presented herein.

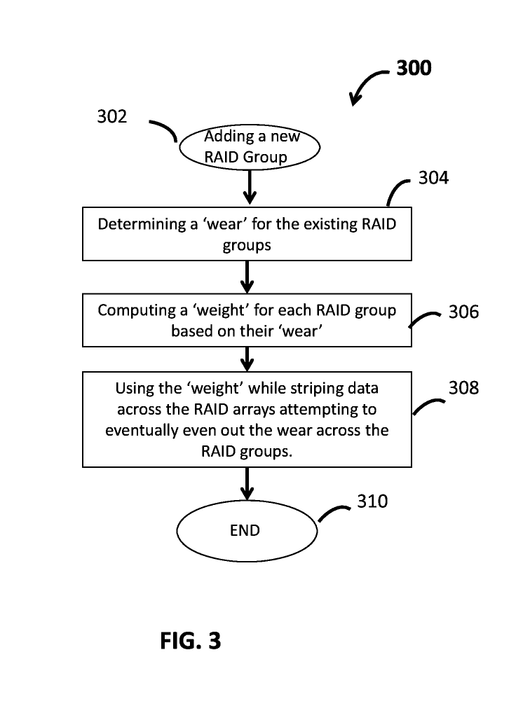

FIG. 3 shows a flow chart 300 of the steps performed when a new RAID group is added to the storage pool 26/226, in accordance with a method of the invention. At step 302, the process starts when one or more new RAID groups are added to the storage system 8 that already has existing RAID groups. Next, at step 304, a ‘wear’ for the existing RAID groups is determined, in accordance with the discussions herein among other suitable and contemplated methods.

Next, at step 306, a ‘weight’ is computed for each RAID group based on the RAID groups' wear′. At step 308, the storage processor 10 uses the assigned weight, based on the wear, to stripe the write data across the RAID groups. The process ends at step 310.

In one embodiment of the invention, when a new set of RAID groups is added to the existing set of RAID groups, the storage processor 10 determines the wear of the existing set of the RAID groups and only uses the newly-added set of RAID groups to stripe the data until the newly-added set of RAID groups reaches the same or near level of wear as that of the existing set of RAID groups. Once both sets of RAID groups have similar level of wear, the storage processor 10 then uses both sets of the RAID groups to stripe the data.

Even though RAID groups within a set are anticipated to have similar wear, in some storage systems, the RAID groups within a set may not necessarily be utilized at the same rate and hence might have different ‘wear’. In one embodiment of the invention, the storage processor 10 maintains a ‘wear’ and ‘weight’ for each RAID group based on its ‘average erase count’ and ‘maximum erase count’ and the storage processor 10 stripes write data across each RAID groups accordingly.

Even though the storage processor 14 tries to wear the RAID groups as evenly as possible to increase the life of the storage system 8 by striping the write data across the RAID groups based on their ‘wear’ or ‘weight’, there might be cases where the RAID groups do not wear at the same rate. In another embodiment, the storage processor 10 periodically recalculates the ‘wear’ and ‘weight’ for the RAID groups even when a new set of RAID groups has not been added to the storage system 8. This is to ensure that the ‘weight’ values being used to stripe the write data across the SSDs in the RAID groups are most current with the wear of the RAID groups.

In one embodiment of the invention, the storage processor 10 reads the ‘average erase count’ and the ‘maximum erase count’ fields in the SMART attributes, known to those in the art, of the SSDs 28 to determine the ‘wear’ and ‘weight’ of the respective RAID groups. For example, an average wear of the SSDs within the RAID group may be used as a ‘wear’ for that RAID group.

In another embodiment, the storage processor 10 may use other fields within the SMART attributes to compute ‘wear’ and ‘weight’. In yet another embodiment, the storage processor 10 may use other schemes to determine the ‘wear’ and ‘weight’ for striping the write data.

In the discussions and figures herein, it is understood that the CPU subsystem 14 executes code (or “software program(s)”) to perform the various tasks discussed. It is contemplated that the same may be done using dedicated hardware or other hardware and/or software-related means.

Although the invention has been described in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

What is claims is:

1. A method of managing redundant array of independent disk (RAID) groups in a storage system, the storage system including a plurality of RAID groups, the method comprising:
determining wear of each of the plurality of RAID groups, the plurality of RAID groups having a storage capacity, each of the plurality of RAID groups including more than one solid state disk (SSD) and the SSDs of the more than one SSD of each of the plurality of RAID groups being utilized at substantially the same rate;
computing weight for each of the plurality of RAID groups based on the determined wear;
upon adding storage capacity to the storage capacity of the plurality of RAID groups, re-computing the weight of each of the plurality of RAID groups; and
after the re-computing step, striping data across at least one of the plurality of RAID groups based on the re-computed weight of each of the plurality of RAID groups.

2. (canceled)

3. The method of claim 1, wherein the striping data step including striping data across all of the plurality of RAID groups based on their weights thereby causing all of the plurality of RAID groups to reach their end-of-life at substantially the same time.

4. The method of claim 1, wherein the striping data step further including striping data less frequently across at least one of the plurality of RAID groups having a wear that is higher than that of a remaining RAID groups of the plurality of RAID groups.

5. The method of claim 1, wherein the striping data step further including striping data evenly across all of the plurality of RAID groups when all the RAID groups of the plurality of RAID groups have substantially the same wear.

6. The method of claim 1, wherein the striping data step further including striping data more frequently across at least one of the plurality of RAID groups having a weight that is higher than that of a remaining RAID groups of the plurality of RAID groups.

7. The method of claim 1, wherein the striping data step includes striping across at least one of the plurality of RAID groups having a lower wear than a remaining RAID group of the plurality of RAID groups until the wear of the at least one of the plurality of RAID groups is substantially the same as the wear of the remaining RAID groups.

8. The method of claim 7, wherein if all of the plurality of RAID groups have substantially the same wear relative to the remaining RAID groups, striping data across all of the RAID groups of plurality of RAID groups.

9. The method of claim 1, further including a storage processor maintaining the wear for each of the plurality of RAID groups.

10. The method of claim 1, wherein the at least one of the plurality of RAID groups further comprises one or more SSDs.

11. (canceled)

12. The method of claim 10, wherein the determining the wear step further including a storage processor reading SMART attributes of the SSDs of the plurality of RAID groups to determine the wear.

13. (canceled)

14. (canceled)

15. (canceled)

16. (canceled)

17. (canceled)

18. (canceled)

19. (canceled)

20. (canceled)

21. (canceled)

22. (canceled)

23. A storage system comprising:
a central processing unit (CPU) subsystem;
a storage processor including a switch and the CPU subsystem, the switch being coupled to the CPU subsystem;
a storage pool coupled to the storage processor through the switch and responsive to data, the storage pool being organized into a plurality of in redundant array of independent disk (RAID) groups, the plurality of RAID groups including two or more solid state disks (SSDs), the SSDs configured to store the data, the CPU subsystem operable to:
determine wear of each of the plurality of RAID groups, the plurality of RAID groups having a storage capacity, each of the plurality of RAID groups including more than one solid state disk (SSD) and the SSDs of the more than one SSD of each of the plurality of RAID groups being utilized at substantially the same rate;
compute weight for each of the plurality of RAID groups based on the determined wear;
store the weight in a memory located within the storage processor;
stripe the data across at least one of the plurality of RAID groups based on the weight of each of the plurality of RAID groups;
upon addition of at least one other RAID group to the plurality of RAID groups, re-compute the weights of the plurality of RAID groups; and
stripe the data across at least one of the plurality of RAID groups based on the re-computed weights.

24. The storage system of claim 23, wherein the switch is a Peripheral Component Interconnect Express type of switch.

25. The storage system of claim 23, wherein the CPU subsystem is further operable to stripe across at least one of the plurality of RAID groups having a lower wear than a remaining RAID group of the plurality of RAID groups until the wear of the at least one of the plurality of RAID groups is substantially the same as the wear of the remaining RAID groups.

26. The storage system of claim 25, wherein if all of the plurality of RAID groups have substantially the same wear relative to the remaining RAID groups, the CPU subsystem being operable to stripe data across all of the RAID groups of plurality of RAID groups.

27. The storage system of claim 23, wherein the CPU subsystem is operable to stripe across all of the plurality of RAID groups.

28. A method of managing redundant array of independent disk (RAID) groups in a storage system, the storage system including a plurality of RAID groups, the method comprising:
determining wear of each of the plurality of RAID groups, each of the plurality of RAID groups including two or more solid state disks (SSDs) and the SSDs of the more than one SSD of each of the plurality of RAID groups being utilized at substantially the same rate;
computing weight for each of the plurality of RAID groups based on the wear;
striping data across all of the SSDs of at least one of the plurality of RAID groups based on the weight of each of the plurality of RAID groups.

29. The method of claim 28, further including upon adding storage capacity to the plurality of RAID groups, re-computing the weights of the plurality of RAID groups, and after the re-computing step, striping data across at least one of the plurality of RAID groups based on the re-computed weights of each of the plurality of RAID groups.

30. The method of claim 28 wherein the striping data step including striping data across all of the SSDs of all the plurality of RAID groups based on their weights thereby causing all of the plurality of RAID groups to reach their end-of-life at substantially the same time.

31. The method of claim 28, wherein the striping data step further including striping data less frequently across at least one of the plurality of RAID groups having a wear that is higher than that of a remaining RAID groups of the plurality of RAID groups.

32. The method of claim 28, wherein the striping data step further including striping data evenly across all of the SSDs of the plurality of RAID groups when all the RAID groups of the plurality of RAID groups have substantially the same wear.

33. The method of claim 28, wherein the striping data step further including striping data more frequently across at least one of the plurality of RAID groups having a weight that is higher than that of a remaining RAID groups of the plurality of RAID groups.

34. The method of claim 28, wherein the striping data step includes striping across at least one of the plurality of RAID groups having a lower wear than a remaining RAID group of the plurality of RAID groups until the wear of the at least one of the plurality of RAID groups is substantially the same as the wear of the remaining RAID groups.

35. The method of claim 34, wherein if all of the plurality of RAID groups have substantially the same wear relative to the remaining RAID groups, striping data across all of the RAID groups of plurality of RAID groups.

36. The method of claim 28, wherein the determining the wear step further including a storage processor reading the wear of each of the SSDs of the plurality of RAID groups.

37. The method of claim 28, wherein the determining the wear step further including a storage processor reading SMART attributes of the SSDs of the plurality of RAID groups to determine the wear.

38. The method of claim 28, wherein determining an average wear of all of the SSDs of a RAID group is used to determine the wear of the RAID group.

39. The method of claim 28, wherein the determining an average wear step is performed for each of the plurality of RAID groups.

40. The method of claim 28, further including storing the weights in a memory.

41. The method of claim 28, further including storing the weights in a non-volatile portion of the memory.

42. The method of claim 28, further including periodically re-determining the wear of each of the plurality of RAID groups.

43. The method of claim 3, wherein the plurality of RAID groups reach end-of-life when their corresponding two or more SSDs are fully worn.

44. The storage system of claim 23, wherein the plurality of RAID groups reach end-of-life when their corresponding two or more SSDs are fully worn.

45. The method of claim 28, wherein the plurality of RAID groups reach end-of-life when their corresponding two or more SSDs are fully worn.
